(19) United States
(12) Patent Application Publication
(10) Pub. No.: US 2020/0240449 A1
(43) Pub. Date: Jul. 30, 2020

(54) ALIGNMENT-VERIFYING SEALABLE SECURING SYSTEMS AND METHODS

(71) Applicant: THE BOEING COMPANY, Chicago, IL (US)

(72) Inventor: Cory Hitchcock, Granite Falls, WA (US)

(73) Assignee: THE BOEING COMPANY, Chicago, IL (US)

(21) Appl. No.: 16/850,082

(22) Filed: Apr. 16, 2020

Related U.S. Application Data
(63) Continuation-in-part of application No. 15/992,256, filed on May 30, 2018.

(51) Int. Cl. F16B 1/00; F16J 15/02; F16J 15/06

(52) U.S. Cl. CPC F16B 1/00; F16B 2001/0028; F16J 15/061; F16J 15/022

(57) ABSTRACT

A sealable securing system and method include a hook member including a first seal. The hook member is configured to be secured to a first component. A first alignment member coupled to the hook member. A loop member includes a second seal. The loop member is configured to be secured to a second component. A second alignment member coupled to the loop member. The first alignment member coupled to the second alignment member verifies that the first seal of the hook member sealingly engages the second seal of the loop member.

### RELATED APPLICATIONS

This application is a continuation-in-part of U.S. patent application Ser. No. 15/992,256, entitled “Sealable Securing Systems and Methods,” filed May 30, 2018, which is hereby incorporated by reference in its entirety.

### FIELD OF EMBODIMENTS OF THE DISCLOSURE

Embodiments of the present disclosure generally relate to securing systems, such as hook and loop securing systems, and more particularly to securing systems that provide a sealing interface between first and second portions and verify alignment of the first and second portions.

### BACKGROUND OF THE DISCLOSURE

As an airplane is operated, moisture may be introduced into a pressurized space from passengers, cargo, and/or the environment that condenses and deposits frost on cold structures and equipment. During aircraft design and manufacture, special consideration is given with respect to the potential of moisture accumulation within the airplane, so as to ensure that corrosion of various internal structures, short-circuiting, arcing, and/or degradation of electrical components, does not occur. Further, designers also seek to minimize occupant discomfort from liquid water dropping from the interior ceiling of the airplane. In general, condensation and deposition are directly related to environmental conditions within an interior cabin of the airplane, and indirectly related to ambient conditions outside of the airplane.

Water accumulation due to condensation and deposition occurs in both short and long range flights, but is generally more prevalent in continuous long-range flights over six hours. Airplanes typically include various moisture management devices to prevent, minimize, reduce, or otherwise control moisture within an interior cabin. For example, drainage paths within various structures, moisture impermeable insulation blankets, dehumidifiers, and moisture management devices are used to capture and/or direct moisture away from the interior cabin and divert the moisture to a bilge, through which the moisture is expelled overboard.

Insulation blankets within an airplane are often connected to one another through hook and loop interfaces. The hook and loop interfaces secure adjacent insulation blankets together along their edges. Testing has shown that moist air can pass through the hook and loop interfaces. The moist air may then contact a sub-freezing component of the airplane during a flight, and be deposited as frost. The frost later melts and can drip or otherwise leak into the interior of the airplane.

The hook and loop interface does not prevent moist air from passing therethrough and being deposited as frost on sub-freezing components. The extent of frost accumulation is a function of cabin humidity and the length of a flight. Humidity is a function of passenger count. For example, four hundred passengers on an eighteen hour flight may generate over one hundred gallons of water, increasing the airplane interior humidity. A quarter of such moisture can then be deposited as frost on sub-freezing components. Hook and loop interfaces between adjacent insulation blankets typically allow passage of the humid air. The passage of humid air increases frost accumulation, which, in turn, leads to water dripping or otherwise leaking into the interior cabin of the airplane.

### SUMMARY OF THE DISCLOSURE

A need exists for a system and method of preventing, minimizing, or otherwise reducing moisture passage through a hook and loop interface. A need exists for a system and method of preventing, minimizing, or otherwise reducing moisture transport through connection interfaces of insulation blankets within an aircraft. Further, a need exists for a system and method of readily, quickly, and easily verifying a sealing engagement between insulation blankets, for example.

With those needs in mind, certain embodiments of the present disclosure provide a sealable securing system that includes a hook member including a first base, at least one hook group coupled to the first base, and a first seal coupled to the first base. The hook member is configured to be secured to a first component. A loop member includes a second base, at least one loop group coupled to the second base, and a second seal coupled to the second base. The loop member is configured to be secured to a second component. The hook member and the loop member are configured to removably secure to one another. The hook group(s) securely connects to the loop group(s) when the hook member is connected to the loop member. The first seal engages the second seal when the hook member is connected to the loop member, thereby providing an improved barrier against moisture transport.

In at least one embodiment, a first hook group is spaced apart from a second hook group, and a first loop group is spaced apart from a second loop group. The first seal may extend from the first base between the first hook group and the second hook group. The second seal may extend from the second base between the first loop group and the second loop group.

The hook group(s) and the first seal may extend along an entire length of the first base. The loop group(s) and the first seal may extend along an entire length of the second base.

In at least one embodiment, the first seal is wider than the second seal. Optionally, the second seal is wider than the first seal.

Each of the first seal and the second seal may be formed of closed-cell foam.

In at least one embodiment, the hook group(s) includes a plurality of hooks, and the loop group(s) includes a plurality of loops. The plurality of hooks is configured to selectively mate with the plurality of loops.

One or both of the first seal or the second seal may include a rounded, outwardly-bowed surface. One or both of the first seal or the second seal may include a bulb seal. One of the first seal or the second seal may include a plurality of resilient blade seals.

Certain embodiments of the present disclosure provide a sealable securing method that includes providing a hook member including a first base, at least one hook group coupled to the first base, and a first seal coupled to the first base on a first component, providing a loop member including a second base, at least one loop group coupled to the second base, and a second seal coupled to the second base on a second component, and removably securing the hook member to the loop member.

In at least one embodiment, the removably securing includes securely connecting the hook group(s) to the loop group(s) when the hook member is connected to the loop member, and sealingly engaging the first seal and the second seal when the hook member is connected to the loop member.

Certain embodiments of the present disclosure provide a vehicle including an interior cabin, a first insulation blanket within the interior cabin, a second insulation blanket within the interior cabin, and a sealable securing system that sealingly and securely connects the first insulation blanket and the second insulation blanket.

Certain embodiments of the present disclosure provide a sealable securing system that includes a hook member including a first seal. The hook member is configured to be secured to a first component. A first alignment member is coupled to the hook member. A loop member includes a second seal. The loop member is configured to be secured to a second component. A second alignment member is coupled to the loop member. The first alignment member coupled to the second alignment member verifies that the first seal of the hook member sealingly engages the second seal of the loop member.

In at least one embodiment, the first alignment member and the second alignment member are formed of a flexible, fluid impermeable material.

In at least one embodiment, the first alignment member is laterally offset from the hook member, and the second alignment member is laterally offset from the loop member.

In at least one embodiment, the first alignment member extends along an entire first length of the hook member, and the second alignment member extends along entire second length of the loop member.

As one example, the first alignment member includes prongs connected to a first base. An interior channel is defined between interior surfaces of the first base and the prongs. The second alignment member includes a rail extending from a second base. The rail is received and retained within the interior channel when the first alignment device is coupled to the second alignment device.

In at least one embodiment, the sealable securing system further includes a first flexible sheet that couples the hook member to the first alignment member, and a second flexible sheet that couples the loop member to the second alignment member. The first flexible sheet and the second flexible sheet may be formed of a flexible, fluid impermeable material. As an example, the first flexible sheet includes a first extended portion of a first base of the hook member, and the second flexible sheet includes a second extended portion of a second base of the loop member.

In at least one other embodiment, the first alignment member is directly coupled to the hook member, and the second alignment member is directly coupled to the loop member.

Certain embodiments of the present disclosure provide a sealable securing method, including coupling a first alignment member to a hook member, wherein hook member includes a first seal, and wherein the hook member is configured to be secured to a first component; coupling a second alignment member to a loop member, wherein the loop member includes a second seal, wherein the loop member is configured to be secured to a second component; and verifying that the first seal of the hook member sealingly engages the second seal of the loop member when the first alignment member is coupled to the second alignment member.

### BRIEF DESCRIPTION OF THE DRAWINGS

FIG. 1 illustrates a top view of a sealable securing system including a hook member and a loop member in a disconnected state, according to an embodiment of the present disclosure.

FIG. 2 illustrates an end view of the sealable securing system including the hook member and the loop member in a connected state.

FIG. 3 illustrates a top view of a sealable securing system including a hook member secured to a first component, and a loop member secured to a second component, according to an embodiment of the present disclosure.

FIG. 4 illustrates a lateral view of the first component connected to the second component via the sealable securing system.

FIG. 5 illustrates a perspective lateral view of a sealable securing system, according to an embodiment of the present disclosure.

FIG. 6 illustrates an end view of a sealable securing system in a disconnected state, according to an embodiment of the present disclosure.

FIG. 7 illustrates an end view of the sealable securing system in a connected state, according to an embodiment of the present disclosure.

FIG. 8 illustrates an end view of a first component connected to a second component by a sealable securing system in which a first seal and a second seal are aligned along respective longitudinal axes, according to an embodiment of the present disclosure.

FIGS. 9 and 10 illustrate end views of the first component connected to the second component by the sealable securing system in which the first seal and the second seal are coupled together and offset from alignment along respective longitudinal axes.

FIG. 11 illustrates an end view of a first component connected to a second component by a sealable securing system, according to an embodiment of the present disclosure.

FIG. 12 illustrates an end view of a first component connected to a second component by a sealable securing system, according to an embodiment of the present disclosure.

FIG. 13 illustrates an end view of a first component connected to a second component by a sealable securing system, according to an embodiment of the present disclosure.

FIG. 14 illustrates a perspective view of the first component connecting to the second component by the sealable securing system, according to an embodiment of the present disclosure.

FIG. 15 illustrates a front perspective view of a vehicle, according to an embodiment of the present disclosure.

FIG. 16 illustrates a perspective internal view of a portion of a fuselage of an aircraft, according to an embodiment of the present disclosure.

FIG. 17 illustrates a perspective internal view of a passenger cabin of an aircraft, according to an embodiment of the present disclosure.

FIG. 18 illustrates a flow chart of a method of securely and sealingly connecting a first component to a second component, according to an embodiment of the present disclosure.

FIG. 19 illustrates a top view of a sealable securing system including a hook member secured to a first component, and a loop member secured to a second component, according to an embodiment of the present disclosure.

FIG. 20 illustrates a flow chart of a method of verifying sealing alignment of the sealable securing system, according to an embodiment of the present disclosure.

FIG. 21 illustrates an end view of a sealable securing system having a hook member secured to a loop member and a first verification member secured to a second verification member, according to an embodiment of the present disclosure.

FIG. 22 illustrates an end view of a sealable securing system having a hook member secured to a loop member and a first verification member secured to a second verification member, according to an embodiment of the present disclosure.

FIG. 23 illustrates an end view of a sealable securing system providing a sealing interface between a first component and a second component, according to an embodiment of the present disclosure.

### DETAILED DESCRIPTION OF THE DISCLOSURE

The foregoing summary, as well as the following detailed description of certain embodiments will be better understood when read in conjunction with the appended drawings. As used herein, an element or step recited in the singular and preceded by the word “a” or “an” should be understood as not necessarily excluding the plural of the elements or steps. Further, references to “one embodiment” are not intended to be interpreted as excluding the existence of additional embodiments that also incorporate the recited features. Moreover, unless explicitly stated to the contrary, embodiments “comprising” or “having” an element or a plurality of elements having a particular property may include additional elements not having that property.

Certain embodiments of the present disclosure provide a sealable securing system and method that includes a hook member and a loop member that are configured to removably secure to one another. The hook member includes at least one group of hooks, while the loop member includes at least one group of loops. The group of hooks and the group of loops are configured to selectively connect and disconnect from one another. In a connected state, the group of hooks and the group of loops securely couple the hook member to the loop member.

The hook member also includes a first seal, while the loop member also includes a second seal. In the connected state, the first seal compressively couples to the second seal, thereby providing a fluid-tight seal therebetween. As such, the compressive coupling between the first seal and the second seal eliminates, prevents, or otherwise reduces fluid (both gas, such as air, and liquid, such as water) passage therebetween and therethrough.

Certain embodiments of the present disclosure provide an alignment verification system coupled to the sealable securing system. In at least one embodiment, a first alignment member is coupled to the hook member, and a second alignment member is coupled to the loop member. The first alignment member and the second alignment member are configured to sealingly couple together to provide a sealing lock therebetween. When the hook member is coupled to the loop member and the first alignment member and the second alignment member are coupled together, the sealing engagement between the hook member and the loop member is verified. Conversely, if the first alignment member and the second alignment member are unable to be coupled together, a sealing engagement between the hook member and the loop member is not verified. In this manner, the alignment verification system is configured to verify sealing engagement between the hook member and the loop member.

In at least one embodiment, the first alignment member and the second alignment member are formed of a flexible, fluid impermeable material, such as a closed cell foam, rubber, and/or the like. As such, when the first alignment member couples to the second alignment member, a fluid impermeable interface is formed therebetween.

In at least one embodiment, the first alignment member couples to the hook member through a first flexible sheet, and the second alignment member couples to the loop member through a second flexible sheet. In at least one embodiment, the first flexible sheet and the second flexible sheet are formed of a flexible, fluid impermeable material, such as closed cell foam, rubber, and/or the like. The first flexible sheet and the second flexible sheet may be extended portions of backing of the hook member and the loop member. The first flexible sheet and the second flexible sheet are sized to extend the first alignment member and the second alignment member within a predetermined range that assures sealing engagement between the hook member and the loop member. That is, the hook member and the loop member need not be precisely aligned to provide an effective sealing interface therebetween. Instead, the hook member and the loop member may be offset from one another within a tolerance that still ensures a sealing engagement between the hook member and the loop member.

In at least one embodiment, the alignment verification system including the first alignment member and the second alignment member is laterally offset from the hook member and the loop member. For example, the alignment verification system extends from sides of the hook member and the loop member. The side-mounted verification system is visible to an individual (such as an installing mechanic), who is able to verify sealing engagement between the hook member and the loop member when the first alignment member couples to the second alignment member.

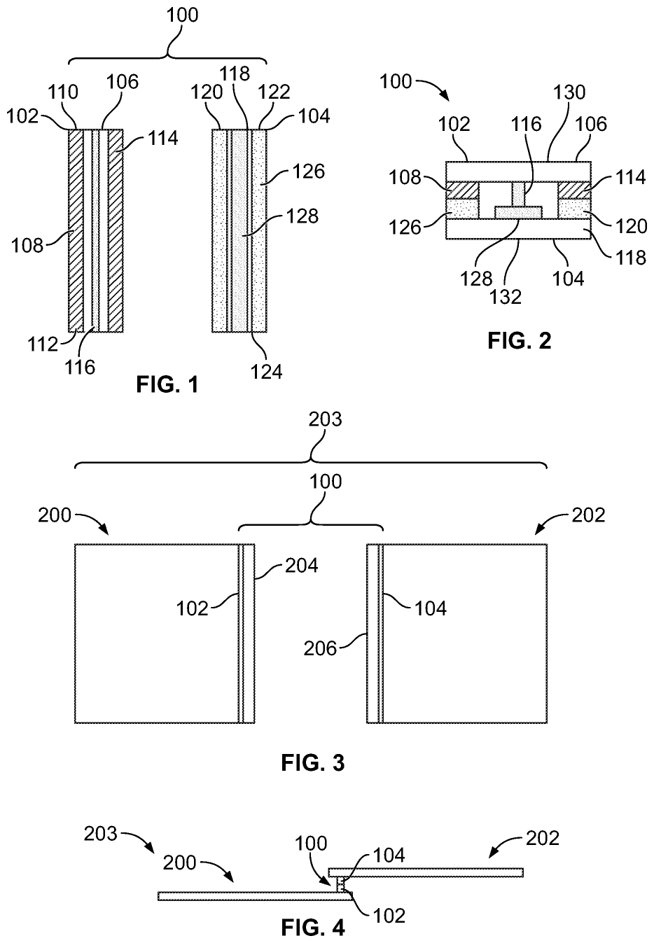

FIG. 1 illustrates a top view of a sealable securing system 100 including a hook member 102 and a loop member 104 in a disconnected state, according to an embodiment of the present disclosure. The hook member 102 and the loop member 104 are configured to selectively connect and disconnect from one another.

The hook member 102 includes a base 106 or backing (for example, a first base), such as a planar strip of plastic, an elastomeric material, a film, and/or the like. A first hook group 108 is coupled to the base 106, and extends along the base 106 from a first end 110 to an opposite second end 112. A second hook group 114 is parallel to the first hook group 108 and extends along the base 106 from the first end 110 to the second end 112. As such, the first hook group 108 and the second hook group 114 may extend along an entire length of the base 106. Alternatively, the hook member 102 may include one of the first hook group 108 or the second hook group 114.

A first seal 116 is coupled to the base 106, and extends from the base 106 between the first hook group 108 and the second hook group 114. The first seal 116 linearly extends along a length of the base 106 from the first end 110 to the second end 112, and may thereby extend along the entire length of the base 106. The first seal 116 may be parallel to the first hook group 108 and the second hook group 114. As shown, the first seal 116 may be spaced apart from the first hook group 108 and the second hook group 114. Optionally, the first seal 116 may abut into an edge of one or both of the first hook group 108 and/or the second hook group 114.

The loop member 104 includes a base 118 or backing (for example, a second base), such as a planar strip of plastic, an elastomeric material, a film, fabric, and/or the like. A first loop group 120 is coupled to the base 118, and extends along the base 118 from a first end 122 to an opposite second end 124. A second loop group 126 is parallel to the first loop group 120 and extends along the base 118 from the first end 122 to the second end 124. Accordingly, the first loop group 120 and the second loop group 126 may extend along an entire length of the base 118. Alternatively, the loop member 104 may include one of the first loop group 120 or the second loop group 126.

A second seal 128 is coupled to the base 118, and extends from the base 118 between the first loop group 120 and the second loop group 126. The second seal 128 linearly extends along a length of the base 118 from the first end 122 to the second end 124, and may thereby extending along an entire length of the base 118. The second seal 128 may be parallel to the first loop group 120 and the second loop group 126. As shown, the second seal 128 may be spaced apart from the first loop group 120 and the second loop group 126. Optionally, the second seal 128 may abut into an edge of one or both of the first loop group 120 and/or the second loop group 126.

As shown, the second seal 128 may be wider than the first seal 116. The wider second seal 128 allows for misalignment when the hook member 102 is mated with the loop member 104. That is, the wider second seal 128 provides a greater surface onto which the first seal 116 is able to engage, thereby reducing the need for a precise alignment and connection between the hook member 102 and the loop member 104. Optionally, the first seal 116 may be wider than the second seal 128. In at least one other embodiment, the first seal 116 and the second seal 128 may have substantially the same width.

When coupled together, the first and second seals 116 and 128 provide a compressible, elastic, and fluid tight barrier. For example, the first and second seals 116 and 128 may be formed of closed-cell foam, an elastomeric material (such as rubber), silicone, fabric, and/or the like. It has been found that the closed-cell foam, in particular, provides an effective fluid-tight seal, while also being relatively light and moisture resistant. As such, the closed-cell foam may be used with applications that seek to reduce overall weight of components (such as with respect to aircraft). In at least one embodiment, the first and second seals 116 and 128 may be formed of the same type of material. In at least one other embodiment, the first and second seals 116 and 128 may be formed of different types of materials. For example, the first seal 116 may be formed of a closed-cell foam, while the second seal 128 may be formed of an elastomeric material.

As described herein, the sealable securing system 100 includes the hook member 102 including the first base 106, at least one hook group 108 and/or 114 coupled to the first base 106, and the first seal 116 coupled to the first base 106. The loop member 104 includes the second base 118, at least one loop group 120 and/or 126 coupled to the second base 118, and the second seal 128 coupled to the second base 118. The hook member 102 is removably secured to for example, selectively connectable to and disconnectable from) the loop member 104. The hook groups 120 and/or 126 securely connects to the at least one loop group when the hook member 102 is connected to the loop member 104, and the first seal 116 sealingly engages the second seal 128 when the hook member 102 is connected to the loop member 104.

In at least one embodiment, the hook groups 108, 114 and the first seal 116 may be secured to the first base 106 through a pressure sensitive adhesive. Similarly, the loop groups 120, 126, and the second seal 128 are secured to the second base 118 through a pressure sensitive adhesive. Further, the hook member 102 and the loop member 104 may be secured to components through a pressure sensitive adhesive, bonding, fasteners, and/or the like.

FIG. 2 illustrates an end view of the sealable securing system 100 including the hook member 102 and the loop member 104 in a connected state. In order to connect the hook member 102 to the loop member 104, the hook member 102 is aligned with the loop member 104 so that the first and second hook groups 108 and 114 engage the first and second loop groups 120 and 126. The first and second hook groups 108 and 114 engage the first and second loop groups 120 and 126 to provide a secure connection therebetween. As the first and second hook groups 108 and 114 secure to the first and second loop groups 120 and 126, the first seal 116 compresses into the second seal 128, thereby providing a fluid-tight sealing interface therebetween. As such, in the connected state, the sealable securing system 100 provides a fluid-tight sealing interface, by way of the first seal 116 and the second seal 128 compressed into one another, between the hook member 102 and the loop member 104. The fluid-tight sealing interface may run an entire length of the hook member 102 and the loop member 104 in the connected state, such as if the first seal 116 extends along an entire length of the hook member 102 and the second seal 128 extends along an entire length of the loop member 104.

As shown in FIG. 2, the wider second seal 128 provides a relatively large surface area onto which the first seal 116 may seat and compressively engage the second seal 128. Consequently, the sealable securing system 100 provides greater tolerance for mating the hook member 102 to the loop member 104, which does not require a precise alignment and positioning between the first seal 116 and the second seal 128 (thereby allowing for an easier and simpler connection process).

The first base 106 and the second base 118 include outer surfaces 130 and 132, respectively, that are configured to be secured to respective components. For example, the outer surfaces 130 and 132 may include adhesives that are configured to secure to components. In at least one other embodiment, the outer surfaces 130 and 132 may be cured and/or bonded to components. In at least one other embodiment, the outer surfaces 130 and 132 may be secured to components through stitches, woven fabric, fasteners, and/or the like. In at least one embodiment, the first base 106 and the second base 118 may each be double-sided tape.

The hook member 102 securely and removably connects to the loop member 104 via the mating of the hook groups 108, 114 with the loop groups 120, 126. The hook member 102 may be selectively removed from the loop member 104, such as by an individual pulling the hook member 102 off the loop member 104, or vice versa, thereby separating the hook groups 108, 114 from the loop groups 120, 126. The hook groups 108, 114 and the loop groups 120, 126 are resilient and configured to selectively connect to one another, as desired. In this manner, the sealable securing system 100 provides a reusable sealing connection.

FIG. 3 illustrates a top view of the sealable securing system 100 including the hook member 102 secured to a first component 200, and the loop member 104 secured to a second component 202, according to an embodiment of the present disclosure. The first component 200 having the hook member 102 and the second component 202 having the loop member 104 provides a component connection system 203. The hook member 102 may extend along an edge 204 of the first component 200, while the loop member 104 may extend along an edge 206 of the second component 202. Optionally, the hook member 102 and the loop member 104 may extend along more than one respective edge of the first component 200 and the second component 202, respectively. Optionally, the hook member 102 may be secured to the second component 202, while the loop member 104 may be secured to the first component 200.

In at least one embodiment, the sealable securing system 100 also includes an alignment verification system coupled to the hook member 102 and the loop member 104. For example, a first alignment member is coupled to the hook member 102, and a second alignment member is coupled to the loop member 104. As described herein, when the hook member 102 is coupled to the loop member 104, the first alignment member coupling to the second alignment member verifies a sealing engagement between the hook member 102 and the loop member 104. Any of the embodiments described with respect to FIGS. 1-18 may include the alignment verification system.

FIG. 4 illustrates a lateral view of the first component 200 connected to the second component 202 via the sealable securing system 100. Referring to FIGS. 3 and 4, the first component 200 may be a first insulation blanket that is configured to be positioned within an aircraft. The second 202 may be a second insulation blanket that is configured to be positioned within the aircraft. The first component 200 securely connects to the second component 202 via the sealable securing system 100. In particular, the hook member 102 sealingly and secureably connects to the loop member 104 (as described herein), thereby securing the first component 200 to the second component 202.

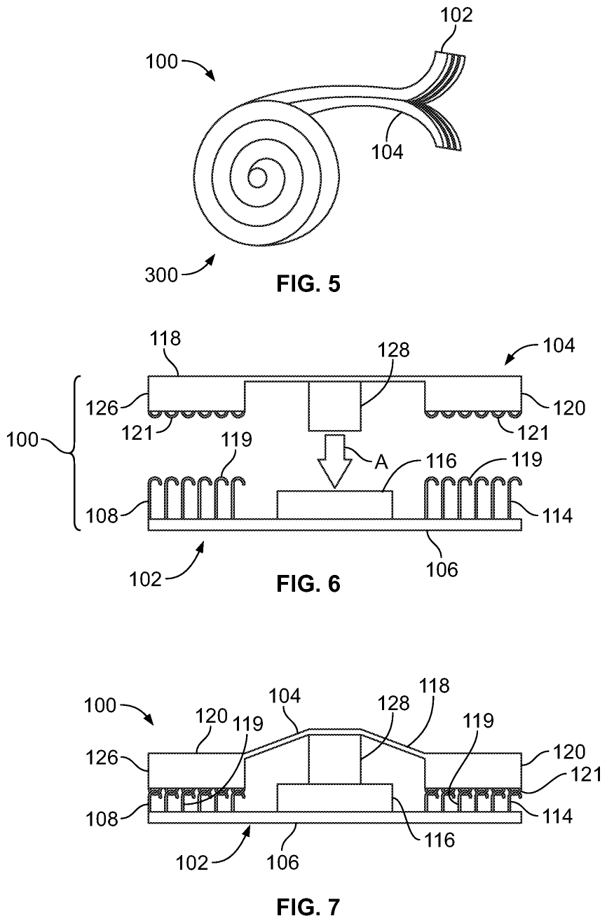

FIG. 5 illustrates a perspective lateral view of the sealable securing system 100, according to an embodiment of the present disclosure. The sealable securing system 100 may be manufactured as a roll or spool 300 in which the hook member 102 is coupled to the loop member 104, as described herein. A desired length of the sealable securing system 100 may be unrolled from the roll 300 and cut at the desired length. The hook member 102 may then be disconnected from the loop member 104, so that the hook member 102 may be secured to a first component (such as the first component 200 shown in FIGS. 3 and 4), and the loop member 104 may be secured to a second component (such as second component 202 shown in FIGS. 3 and 4).

FIG. 6 illustrates an end view of the sealable securing system 100 in a disconnected state, according to an embodiment of the present disclosure. As shown in FIG. 6, the first seal 116 may be wider than the second seal 128. Optionally, the second seal 128 may be wider than the first seal 116. The first seal 116 and the second seal 128 may be a formed as rectangular cross-sectional ridges, bars, beds, plates, or the like. Optionally, the first seal 116 and the second seal 128 may be shaped having various other cross-sections, such as circular, semi-circular, triangular, or the like.

The hook groups 108 and 114 each include a plurality of hooks 119. Similarly, the loop groups 120 and 126 each include a plurality of loops 121. The hooks 119 are configured to selectively mate with the loops 121.

In order to secure the hook member 102 to the loop member 104, the first seal 116 and the second seal 128 are faced towards one another, and linearly aligned. The wider first seal 116 allows for greater alignment tolerance between the first seal 116 and the second seal 128. Once the first seal 116 and the second seal 128 are linearly aligned, the hook member 102 and the loop member 104 are urged together in the direction of arrow A.

FIG. 7 illustrates an end view of the sealable securing system 100 in a connected state, according to an embodiment of the present disclosure. In the connected state, the hooks 119 of the hook groups 108 and 114 securely hook into the reciprocal loops 121 of the loop groups 120 and 126, thereby securely connecting the hook member 102 to the loop member 104. At the same time, the first seal 116 and the second seal 128 compress together, thereby providing a fluid-tight, sealing interface within the sealable securing system 100.

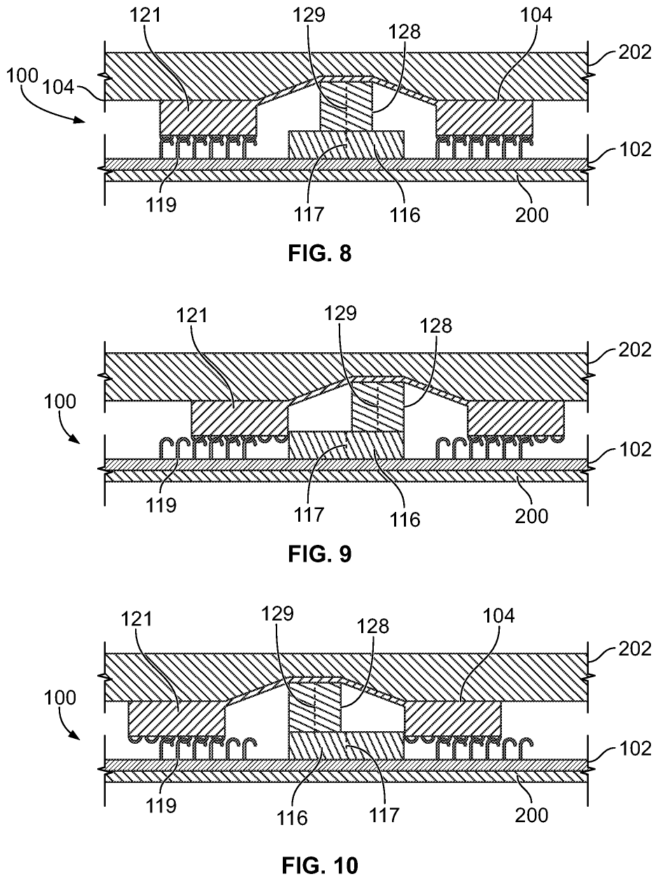

FIG. 8 illustrates an end view of the first component 200 connected to the second component 202 by the sealable securing system 100 in which the first seal 116 and the second seal 128 are aligned along respective longitudinal axes 117 and 129, according to an embodiment of the present disclosure. FIGS. 9 and 10 illustrate end views of the first component 200 connected to the second component 202 by the sealable securing system 100 in which the first seal 116 and the second seal 128 are coupled together and offset from alignment along respective longitudinal axes 117 and 129.

Referring to FIGS. 8-10, because the first seal 116 is substantially wider than the second seal 128, the first and second components 200 and 202 may be secured together such that the first seal 116 need not be precisely aligned and mated with the second seal 128, such as by a precise alignment of the longitudinal axis 117 of first seal 116 and the longitudinal axis 129 of the second seal 128. Accordingly, the process of securing the first component 200 to the second component 202 is simpler and quicker.

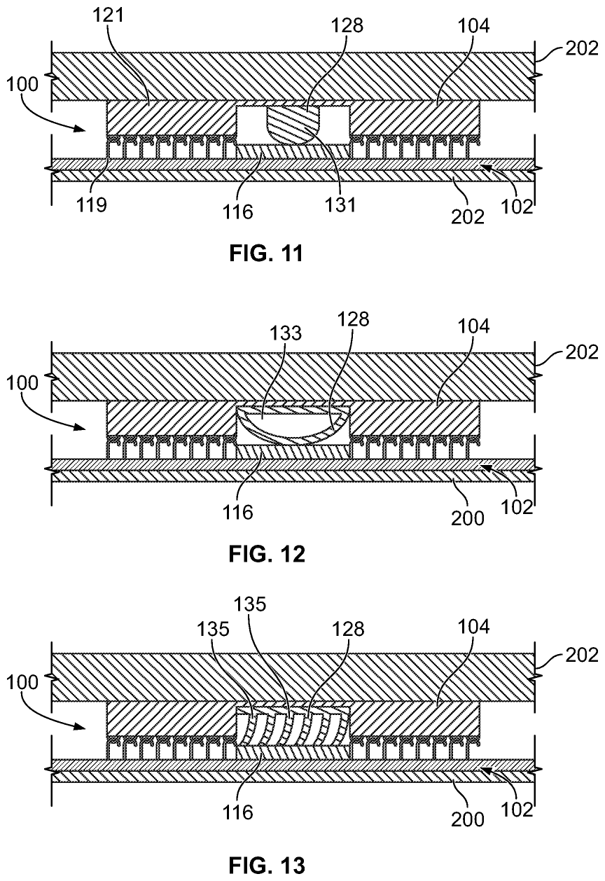

FIG. 11 illustrates an end view of the first component 200 connected to the second component 200 by the sealable securing system 100, according to an embodiment of the present disclosure. In this embodiment, the second seal 128 may include an outwardly-bowed surface 131. The second seal 128 may be formed as a rounded seal having the outwardly-bowed surface 131, which may allow for increased engagement between the hooks 119 and the loops 121. Further, the rounded, outwardly-bowed surface 131 allows for increased angular and/or radial connection between the first seal 116 and the second seal 128. Optionally, the first seal 116 may be formed having the outwardly-bowed surface 131, while the second seal 128 may be formed as a wider, flat and planar seal. In at least one embodiment, both the first seal 116 and the second seal 128 may include a rounded, outwardly-bowed surface.

FIG. 12 illustrates an end view of the first component 200 connected to the second component 202 by the sealable securing system 100, according to an embodiment of the present disclosure. In this embodiment, the second seal 128 may be formed as a bulb seal 133. Optionally, the first seal 116 may be formed as a bulb seal, while the second seal 128 may be formed as a flat, planar seal. In at least one embodiment, each of the first seal 116 and the second seal 128 may be formed as bulb seals.

FIG. 13 illustrates an end view of the first component 200 connected to the second component 200 by the sealable securing system 100, according to an embodiment of the present disclosure. In this embodiment, the second seal 128 may include a plurality of resilient blade seals 135, which may be formed of an elastomeric material. Optionally, the first seal 116 may include blade seals while the second seal 128 may be formed as a flat, planar seal.

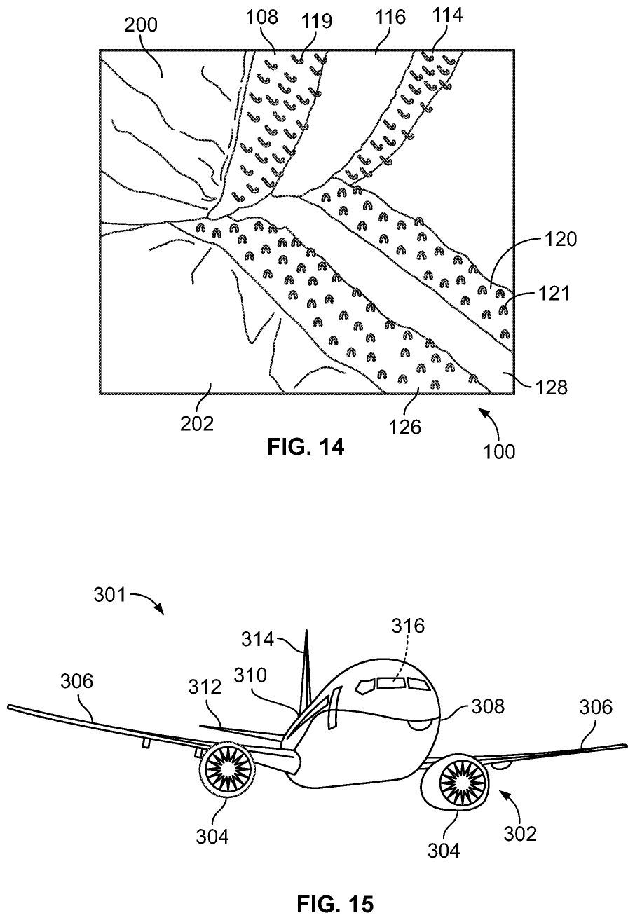

FIG. 14 illustrates a perspective view of the first component 200 connecting to the second component 202 by the sealable securing system 100, according to an embodiment of the present disclosure. As the hook groups 108 and 114 securely mate with the loop groups 126 and 120, respectively, the first seal 116 and the second seal 128 compressively engage together, thereby providing a fluid-tight sealing interface that prevents, minimizes, or otherwise reduces fluid (for example, air and water) infiltration through the connection interface defined by the sealable securing system 100 in the connected state between the first component 200 and the second component 202.

FIG. 15 illustrates a front perspective view of a vehicle, such as an aircraft 301, according to an embodiment of the present disclosure. The aircraft 301 includes a propulsion system 302 that may include two turbofan engines 304, for example. Optionally, the propulsion system 302 may include more engines 304 than shown. The engines 304 are carried by wings 306 of the aircraft 301. In other embodiments, the engines 304 may be carried by a fuselage 308 and/or an empennage 310. The empennage 310 may also support horizontal stabilizers 312 and a vertical stabilizer 314.

The fuselage 308 of the aircraft 301 defines an interior cabin 316, which may include a cockpit, one or more work sections (for example, galleys, personnel carry-on baggage areas, and the like), one or more passenger sections (for example, first class, business class, and coach sections), and an aft section. The interior cabin 316 includes components (such as insulation blankets) removably connected together through sealable securing systems 100, as shown and described with respect to FIGS. 1-15. Alternatively, instead of an aircraft, embodiments of the present disclosure may be used with various other vehicles, such as automobiles, buses, locomotives and train cars, seacraft, spacecraft, and the like. Further, embodiments of the present disclosure may be used with various other systems, structures, components, and/or the like, whether or not part of a vehicle.

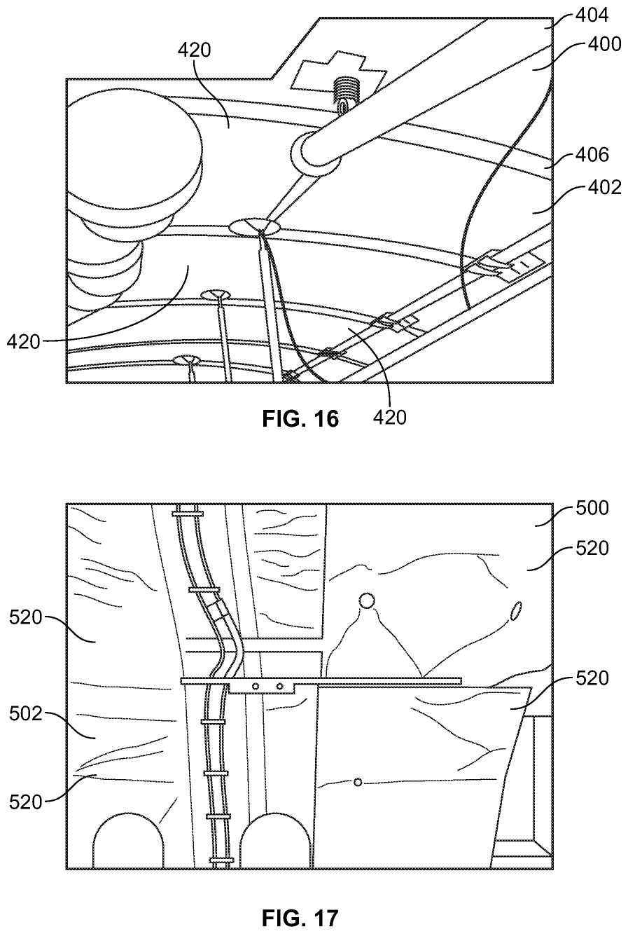

FIG. 16 illustrates a perspective internal view of a portion of a fuselage 400 of an aircraft, according to an embodiment of the present disclosure. The fuselage 400 defines an internal chamber 402 that may include structural supports, such as beams 404 and cross beams 406 that support panels. A plurality of insulation blankets 420 are secured to one another, the beams 404, and/or the cross beams 406. The insulation blankets 420 are removably connected to one another, the beams 404, and/or the cross beams 406 through sealable securing systems 100, such as shown and described with respect to FIGS. 1-15.

FIG. 17 illustrates a perspective internal view of a passenger cabin 500 of an aircraft, according to an embodiment of the present disclosure. The passenger cabin 500 includes an outer wall 502 that defines one or more windows 504. For the sake of clarity, an inner covering wall is not shown in FIG. 17. A plurality of insulation blankets 520 are secured to one another, and/or other structural features. The insulation blankets 520 are removably connected to one another, and/or the other structural features through sealable securing systems 100, such as shown and described with respect to FIGS. 1-15.

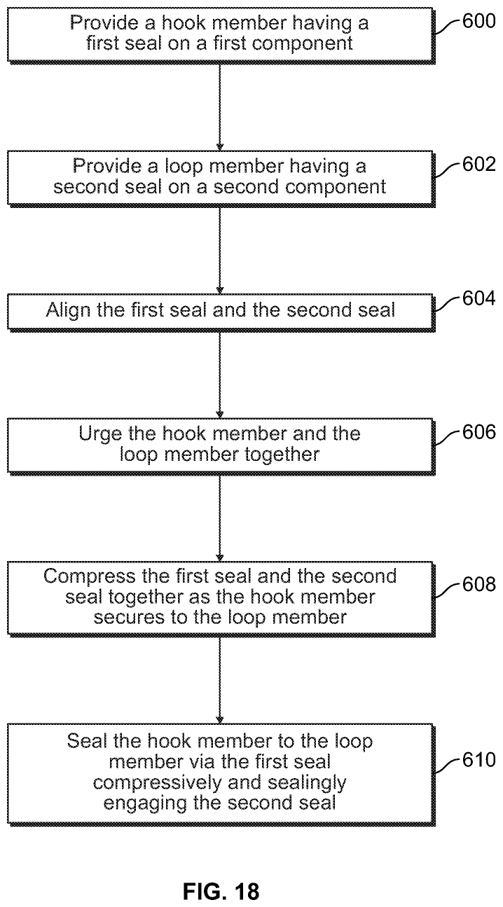

FIG. 18 illustrates a flow chart of a method of securely and sealingly connecting a first component to a second component, according to an embodiment of the present disclosure. In at least one embodiment, the systems and methods described herein provide sealable securing methods of reducing moisture infiltration into an interior cabin of a vehicle, such as an aircraft. Referring to FIGS. 1-4 and 18, at 600, the hook member 102 having the first seal 116 is provided on the first component 200. At 602, the loop member 104 having the second seal 128 is provided on the second component 202. Optionally, the loop member 104 may be provided on the first component 200, while the hook member 102 may be provided on the second component 202.

At 604, the first seal 116 and the second seal 128 are faced towards one another and linearly aligned. At 606, the hook member 102 and the loop member 104 are urged together.

At 608, the first seal 116 and the second seal 128 are compressed together as the hook member 102 secures to the loop member 104. At 610, the hook member 102 is sealed to the loop member 104 via the first seal 116 compressively and sealingly engaging the second seal 128, thereby providing a fluid-tight seal at a connection interface between the first component 200 and the second component 202.

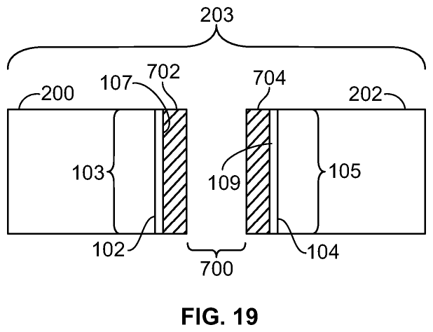

FIG. 19 illustrates a top view of the sealable securing system 100 including the hook member 102 secured to the first component 200, and the loop member 104 secured to the second component 202, according to an embodiment of the present disclosure. The sealable securing system 100 further includes an alignment verification system 700. The alignment verification system 700 includes a first alignment member 702 coupled to the hook member 102, and a second alignment member 704 coupled to the loop member 104. For example, the first alignment member 702 extends laterally from the hook member 102, and the second alignment member 704 extends laterally from the loop member 104.

In operation, the first component 200 and the second component 202 are aligned with respect to one another so that the hook member 102 is configured to mate with the loop member 104, as described above. Further, the first alignment member 702 is aligned in relation to the second alignment member 704 in order to securely mate together. The hook member 102 and the loop member 104 are coupled together. After the hook member 102 and the loop member 104 are coupled together, an individual mates the first alignment member 702 with the second alignment member 704. For example, an individual may press the first alignment member 702 together with the second alignment member 704 and slide fingers over a mating interface therebetween to ensure a secure mating therebetween. When the first alignment member 702 securely mates with the second alignment member 702, a sealing interface between the hook member 102 and the loop member 104 (as described above) is confirmed. If, however, the first alignment member 702 is unable to securely mate with the second alignment member 704, then an individual readily determines that the hook member 702 is not properly aligned with the loop member 704 to provide a proper sealing interface. As such, the hook member 102 and the loop member 104 need to be re-aligned and re-mated.

In at least one embodiment, the first alignment member 702 laterally extends from the hook member 102 along an entire length 103 of the hook member 102. Similarly, the second alignment member 704 laterally extends from the loop member 104 along an entire length 105 of the loop member 102. Optionally, the first alignment member 702 may extend along less than the entire length 103 of the hook member 102, and/or the second alignment member 704 may extend along less than the entire length 105 of the loop member 104. As another example, the first alignment member 702 may include segments separated from one another. For example, the first alignment member 702 may include a first segment at a first end of the hook member 102, and a second segment at an opposite second end of the hook member 102. The first segment and the second segment may be separated from one another. One or more intermediate segments may be positioned along the hook member 102 between the first segment and the second segment. Similarly, the second alignment member 704 may include a first segment at a first end of the loop member 104, and a second segment at an opposite second end of the loop member 104. The first segment and the second segment may be separated from one another. One or more intermediate segments may be positioned along the loop member 104 between the first segment and the second segment.

The first alignment member 702 and the second alignment member 704 are configured to sealingly couple together to provide a sealing lock therebetween. In at least one embodiment, the first alignment member 702 and the second alignment member 704 are formed of a flexible, fluid impermeable material, such as a closed cell foam, rubber, and/or the like. As such, when the first alignment member 702 couples to the second alignment member 704, a fluid impermeable interface is formed therebetween. Alternatively, one or both of the first alignment member 702 and the second alignment member 704 may not be formed of a fluid impermeable material.

In at least one embodiment, the first alignment member 702 and the second alignment member 704 are laterally offset from the hook member 102 and the loop member 104, respectively. For example, the first alignment member 702 extends from a lateral edge 107 of the hook member 102, and the second alignment member 704 extends from a lateral edge 109 of the loop member 104. The alignment verification system 700, which is side-mounted in relation to the hook member 102 and the loop member 104, is readily visible to an individual (such as an installing mechanic), who is able to verify sealing engagement between the hook member and the loop member when the first alignment member 702 couples to the second alignment member 704.

Referring to FIGS. 1-19, in at least one embodiment, the sealable securing system 100 includes the hook member includes the first seal 116. The hook member 102 is configured to be secured to the first component 200. The first alignment member 702 is coupled to the hook member 102 (either directly or through a first flexible sheet). The loop member 104 includes the second seal 128. The loop member 104 is configured to be secured to the second component 202. The second alignment member 704 is coupled to the loop member 104. The first alignment member 702 coupled to the second alignment member 704 verifies that the first seal 116 of the hook member 102 sealingly engages the second seal 128 of the loop member 104.

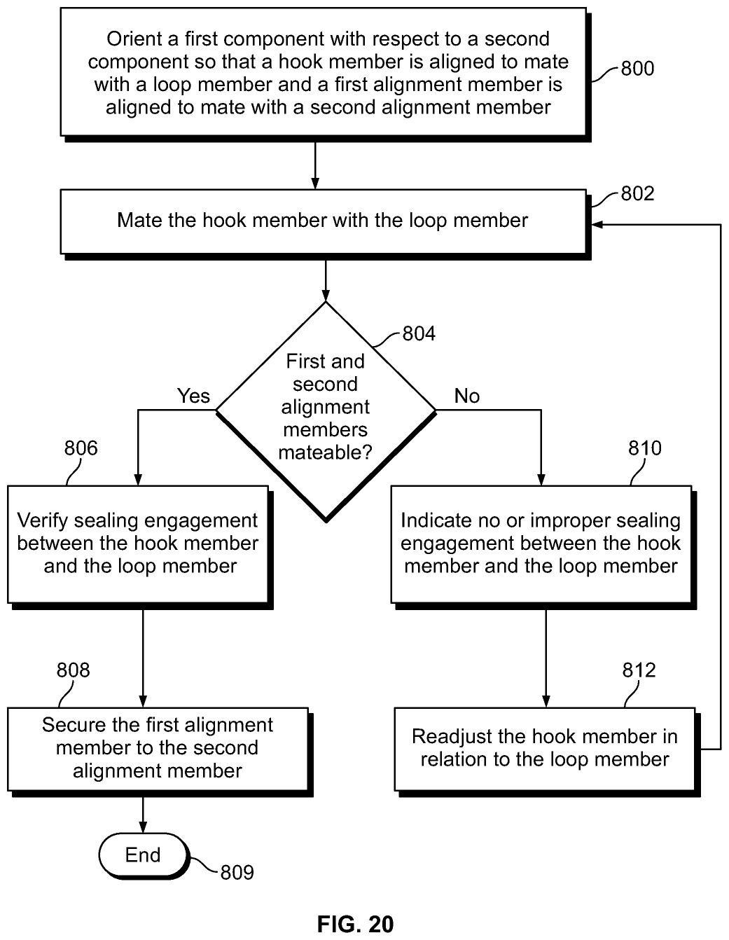

FIG. 20 illustrates a flow chart of a method of verifying sealing alignment of the sealable securing system 100, according to an embodiment of the present disclosure. Referring to FIGS. 19 and 20, the method begins at 800, at which the first component 200 is oriented with respect to the second component 202 so that the hook member 102 is aligned to mate with the loop member 104 and the first alignment member 702 is aligned to mate with the second alignment member 704. At 802, the hook member 102 is mated with the loop member 104.

At 804, it is determined if the first alignment member 702 is mateable with the second alignment member 704. If so, at 806, sealing engagement between the hook member 102 and the loop member 104 is verified. At 808, the first alignment member 702 is secured to the second alignment member 704 (such as to provide a sealing lock therebetween). The method then ends at 809.

If, however, the first alignment member 702 is not mateable with the second alignment member 704 at 804, the method proceeds to 810, at which there is an indication of no or improper sealing engagement between the hook member 102 and the loop member 104. That is, the inability of the first alignment member 702 to securely mate with the second alignment member 704 provides a readily observable indication that there is no or an improper sealing engagement between the hook member 102 and the loop member 104. Then, at 812, the hook member 102 is readjusted in relation to the loop member 104 in an effort to provide a proper sealing engagement therebetween, and the method returns to 802.

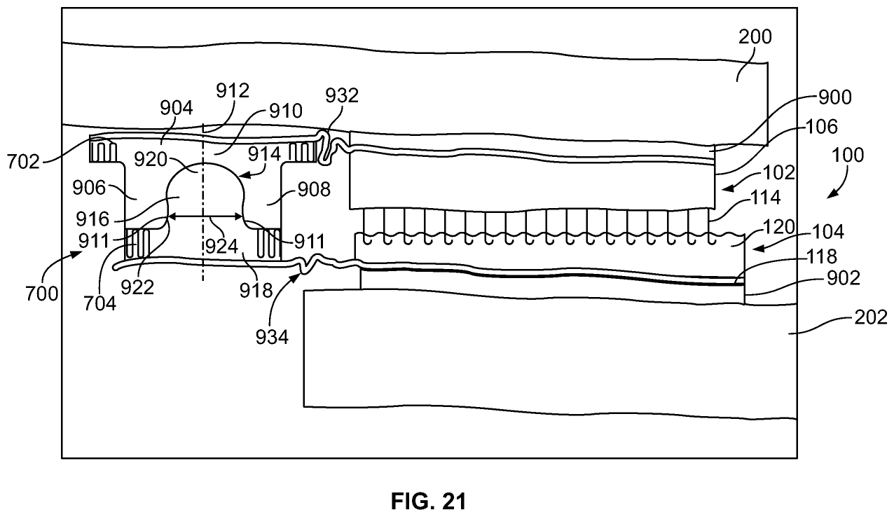

FIG. 21 illustrates an end view of the sealable securing system 100 having the hook member 102 secured to the loop member 104 and the first verification member 702 secured to the second verification member 704, according to an embodiment of the present disclosure. The hook member 102 is secured to the first component 200. For example, the base 106 or backing of the hook member 102 is secured to the first component 200 through an adhesive layer 900. Similarly, the loop member 104 is secured to the second component 202. For example, the base 118 or backing of the loop member 104 is secured to the second component 202 through an adhesive layer 902.

As shown in FIG. 21, the alignment verification system 100 verifies that the hook member 102 sealingly engages the loop member 104, as described herein. In particular, the first verification member 702 secured to the second verification member 704 confirms the sealing engagement between the hook member 102 and the loop member 104.

The first alignment member 702 extends from the hook member 102, and the second alignment member 704 extends from the loop member 104. Optionally, the first alignment member 702 extends from the loop member 104, and the second alignment member 704 extends from the hook member 102.

In at least one embodiment, the first alignment member 702 includes a main body 904 including opposed longitudinal prongs 906 and 908 connected to a longitudinal base 910. The prongs 906 and 908 and the base 910 extend along a length (such as the entire length) of first alignment member 702. Interior end surfaces 911 of the prongs 906 and 908 are expanded and extend inwardly toward a central longitudinal plane 912 of the alignment verification system 100. An interior channel 914 is defined between interior surfaces of the base 910 and the prongs 906 and 908. The interior channel 914 is configured to receive and retain a rail 916 of the second alignment member 704.

In at least one embodiment, the second alignment member 704 includes the rail 916 extending from a base 918. The rail 916 and the base 918 extend along a length (such as the entire length) of the second alignment member 704. The rail 916 includes an expanded head 920 that is wider than a neck 922. The expanded head 920 is wider than a spacing 924 between the interior end surfaces 911 of the prongs 906 and 908.

The rail 916 is sized and shaped to conform to the interior channel 914. When the first alignment member 702 is mated with the second alignment member 704, the rail 916 is urged between the prongs 906 and 908, thereby deflecting the prongs 906 and 908 apart until the prongs 906 and 908 engage around the neck 922. As the prongs 906 and 908 engage the neck 922, the prongs 906 and 908 inwardly deflect back to at-rest positions, thereby providing a locking interface between the rail 916 and the interior surfaces of the second alignment member 704 that define the interior channel 914.

Accordingly, in at least one embodiment, the first alignment member 702 includes the prongs 906 and 908 connected to the base 910. The interior channel 914 is defined between interior surfaces of the base 910 and the prongs 906 and 908. The second alignment member 704 includes the rail 916 extending from the base 918. The rail 916 is received and retained within the interior channel 914 when the first alignment device 702 is coupled to the second alignment device 704.

The interior channel 914 and the rail 916 may have arcuate axial cross-sections. Optionally, the interior channel 914 and the rail 916 may have different axial cross-sections, such as triangular, rectangular, irregularly-shaped, or the like.

In at least one embodiment, the mating relationship between the first alignment member 702 and the second alignment member 704 provides a fluid tight-seal, such as when the first alignment member 702 and the second alignment member 704 are formed of fluid impermeable materials (for example, closed cell foam, an elastomeric material such as rubber, or the like).

As shown, the alignment verification system 700 is laterally offset from the hook member 102 and the loop member 104. Accordingly, the alignment verification system 700 is readily visible by individuals (such as installation mechanics), and provides a readily apparent notification as to whether the hook member 102 sealingly engages the loop member 104 (such as when the first verification member 702 mates with the second verification member 704) or not (such as when the first verification member 702 does not mate with the second verification member 704).

In at least one embodiment, the first alignment member 702 couples to the hook member 102 through a first flexible sheet 932, and the second alignment member 704 couples to the loop member 104 through a second flexible sheet 934. The first flexible sheet 932 and the second flexible sheet 934 are formed of a flexible, fluid impermeable material, such as closed cell foam, rubber, and/or the like. The first flexible sheet 932 and the second flexible sheet 934 may be extended portions of the bases 106 and 118 or backings, respectively.

The first flexible sheet 932 and the second flexible sheet 934 are sized to extend the first alignment member 702 and the second alignment member 704, respectively, within a predetermined range that assures sealing engagement between the hook member 102 and the loop member 104. For example, in flat, unfolded positions, the first flexible sheet 932 and the second flexible sheet 934 may be 2 inches long or less (such as 0.25 inches long). The lengths of the first flexible sheet 932 and the second flexible sheet 934 are determined based on a sealing engagement tolerance between the hook member 102 and the loop member 104. That is, as explained above, the hook member 102 and the loop member 104 need not be precisely aligned to provide an effective sealing interface therebetween. Instead, the hook member 102 and the loop member 104 may be offset from one another within a tolerance that still ensures a sealing engagement between the hook member 102 and the loop member 104 (such as shown and described with respect to FIGS. 9 and 10, for example).

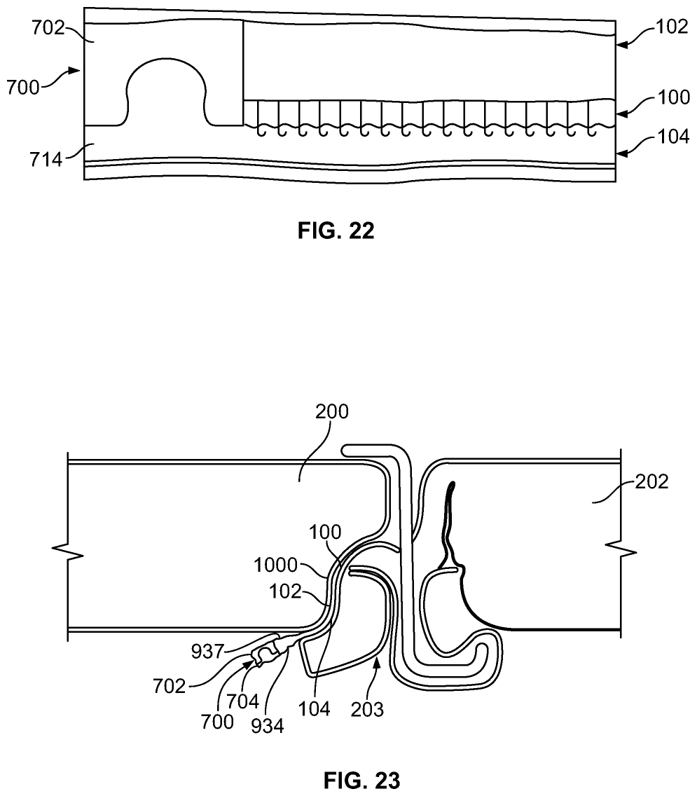

FIG. 22 illustrates an end view of the sealable securing system 100 having the hook member 102 secured to the loop member 104 and the first verification member 702 secured to the second verification member 704, according to an embodiment of the present disclosure. In this embodiment, the first verification member 702 is directly coupled to the hook member 102, and the second verification member 704 is directly coupled to the loop member 104 without flexible sheets. As such, the hook member 102 and the loop member 104 mate with each other over a narrower tolerance range in order for the first verification member 702 to mate with the second verification member 704.

FIG. 23 illustrates an end view of the sealable securing system 100 providing a sealing interface 1000 between the first component 200 and the second component 202, according to an embodiment of the present disclosure. The first component 200 may be a first insulation blanket within an aircraft, and the second component 202 may be a second insulation blanket within the aircraft. As shown, a portion of the second component 202 (and/or the first component 200) may be folded proximate to the sealing interface 1000. The alignment verification system 700 extends outwardly away from the sealing interface 1000, and, as such, is readily visible by individuals.

In at least one embodiment, the first verification member 702, the second verification member 704, the first flexible sheet 932, and the second flexible sheet 934 are formed of fluid impermeable materials. Accordingly, the entirety of the sealable securing system 100 provides a fluid-tight sealing interface when the hook member 102 is secured to the loop member 104 and the first verification member 702 is secured to the second verification member 704.

Referring to FIGS. 19-23, by laterally offsetting the alignment verification system 100 from the hook member 102 and the loop member 104, an individual is able to readily and easily confirm a sealing engagement between the hook member 102 and the loop member 104, even if the hook member 102 is not precisely aligned with the loop member 104 (such as when the alignment verification system 100 connects to the hook member 102 and the loop member 104 through one or more flexible sheets).

As described herein, embodiments of the present disclosure provide systems and methods of preventing, minimizing, or otherwise reducing fluid infiltration through a hook and loop interface. Further, embodiments of the present disclosure provide systems and methods of preventing, minimizing, or otherwise reducing moisture from passing through connection interfaces of insulation blankets within an aircraft. Further, embodiments of the present disclosure Further, embodiments of the present disclosure provide systems and methods of readily, quickly, and easily verifying a sealing engagement between hook and loop member.

While various spatial and directional terms, such as top, bottom, lower, mid, lateral, horizontal, vertical, front and the like may be used to describe embodiments of the present disclosure, it is understood that such terms are merely used with respect to the orientations shown in the drawings. The orientations may be inverted, rotated, or otherwise changed, such that an upper portion is a lower portion, and vice versa, horizontal becomes vertical, and the like.

As used herein, a structure, limitation, or element that is “configured to” perform a task or operation is particularly structurally formed, constructed, or adapted in a manner corresponding to the task or operation. For purposes of clarity and the avoidance of doubt, an object that is merely capable of being modified to perform the task or operation is not “configured to” perform the task or operation as used herein.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the various embodiments of the disclosure without departing from their scope. While the dimensions and types of materials described herein are intended to define the parameters of the various embodiments of the disclosure, the embodiments are by no means limiting and are exemplary embodiments. Many other embodiments will be apparent to those of skill in the art upon reviewing the above description. The scope of the various embodiments of the disclosure should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, the terms “first,” “second,” and “third,” etc. are used merely as labels, and are not intended to impose numerical requirements on their objects. Further, the limitations of the following claims are not written in means-plus-function format and are not intended to be interpreted based on 35 U.S.C. § 112(f), unless and until such claim limitations expressly use the phrase “means for” followed by a statement of function void of further structure.

This written description uses examples to disclose the various embodiments of the disclosure, including the best mode, and also to enable any person skilled in the art to practice the various embodiments of the disclosure, including making and using any devices or systems and performing any incorporated methods. The patentable scope of the various embodiments of the disclosure is defined by the claims, and may include other examples that occur to those skilled in the art. Such other examples are intended to be within the scope of the claims if the examples have structural elements that do not differ from the literal language of the claims, or if the examples include equivalent structural elements with insubstantial differences from the literal language of the claims.

What is claimed is:

1. A sealable securing system, comprising:
a hook member including a first seal, wherein the hook member is configured to be secured to a first component;
a first alignment member coupled to the hook member;
a loop member including a second seal, wherein the loop member is configured to be secured to a second component;
a second alignment member coupled to the loop member,
wherein the first alignment member coupled to the second alignment member verifies that the first seal of the hook member sealingly engages the second seal of the loop member.

2. The sealable securing system of claim 1, wherein the first alignment member and the second alignment member are formed of a flexible, fluid impermeable material.

3. The sealable securing system of claim 1, wherein the first alignment member is laterally offset from the hook member, and wherein the second alignment member is laterally offset from the loop member.

4. The sealable securing system of claim 1, wherein the first alignment member extends along an entire first length of the hook member, and wherein the second alignment member extends along entire second length of the loop member.

5. The sealable securing system of claim 1, wherein the first alignment member comprises prongs connected to a first base, wherein an interior channel is defined between interior surfaces of the first base and the prongs, wherein the second alignment member comprises a rail extending from a second base, and wherein the rail is received and retained within the interior channel when the first alignment device is coupled to the second alignment device.

6. The sealable securing system of claim 1, further comprising:
a first flexible sheet that couples the hook member to the first alignment member; and
a second flexible sheet that couples the loop member to the second alignment member.

7. The sealable securing system of claim 6, wherein the first flexible sheet and the second flexible sheet are formed of a flexible, fluid impermeable material.

8. The sealable securing system of claim 6, wherein the first flexible sheet comprises a first extended portion of a first base of the hook member, and wherein the second flexible sheet comprises a second extended portion of a second base of the loop member.

9. The sealable securing system of claim 1, wherein the first alignment member is directly coupled to the hook member, and wherein the second alignment member is directly coupled to the loop member.

10. The sealable securing system of claim 1, wherein the hook member further comprises a first base, and at least one hook group coupled to the first base, and wherein the loop member further comprises a second base, and at least one loop group coupled to the second base.

11. The sealable securing system of claim 10, wherein the at least one hook group comprises a first hook group spaced apart from a second hook group, and wherein the at least one loop group comprises a first loop group spaced apart from a second loop group.

12. The sealable securing system of claim 11, wherein the first seal extends from the first base between the first hook group and the second hook group, and wherein the second seal extends from the second base between the first loop group and the second loop group.

13. A sealable securing method, comprising:
coupling a first alignment member to a hook member, wherein hook member includes a first seal, and wherein the hook member is configured to be secured to a first component;
coupling a second alignment member to a loop member, wherein the loop member includes a second seal, wherein the loop member is configured to be secured to a second component; and
verifying that the first seal of the hook member sealingly engages the second seal of the loop member when the first alignment member is coupled to the second alignment member.

14. The sealable securing method of claim 13, further comprising forming the first alignment member and the second alignment member of a flexible, fluid impermeable material.

15. The sealable securing method of claim 13, wherein said coupling the first alignment member comprises laterally offsetting the first alignment member from the hook member, and wherein said coupling the second alignment member comprises laterally offsetting the second alignment member from the loop member.

16. The sealable securing method of claim 13, wherein said coupling the first alignment member comprises coupling the hook member to the first alignment member by a first flexible sheet, and wherein said coupling the second alignment member comprises coupling the loop member to the second alignment member by a second flexible sheet.

17. The sealable securing method of claim 16, further comprising forming the first flexible sheet and the second flexible sheet of a flexible, fluid impermeable material.

18. The sealable securing method of claim 13, wherein said coupling the first alignment member comprises directly coupling the first alignment member to the hook member, and wherein said coupling the second alignment member comprises directly coupling the second alignment member to the loop member.

19. A vehicle comprising:
an interior cabin;
a first insulation blanket within the interior cabin;
a second insulation blanket within the interior cabin; and
a sealable securing system that sealingly and securely connects the first insulation blanket and the second insulation blanket, wherein the sealable securing system comprises:
a hook member secured to the first insulation blanket, wherein the hook member includes a first seal;
a first alignment member coupled to the hook member, wherein the first alignment member is formed of a flexible, fluid impermeable material, wherein the first alignment member is laterally offset from the hook member;
a first flexible sheet that couples the hook member to the first alignment member;
a loop member secured to the second insulation blanket, wherein the loop member includes a second seal;
a second alignment member coupled to the loop member, wherein the second alignment member is also formed of the flexible, fluid impermeable material, wherein the second alignment member is laterally offset from the loop member; and
a second flexible sheet that couples the loop member to the second alignment member,
wherein the first alignment member coupled to the second alignment member verifies that the first seal of the hook member sealingly engages the second seal of the loop member.

20. The vehicle of claim 15, wherein the first alignment member comprises prongs connected to a first base, wherein an interior channel is defined between interior surfaces of the first base and the prongs, wherein the second alignment member comprises a rail extending from a second base, and wherein the rail is received and retained within the interior channel when the first alignment device is coupled to the second alignment device.
